(19) United States
(12) Patent Application Publication
(10) Pub. No.: US 2017/0172176 A1
(43) Pub. Date: Jun. 22, 2017

(54) PET FOOD PALATANT COMPOSITION COMPRISING MIXED ALKALI METAL PYROPHOSPHATES

(71) Applicant: Innophos Inc., Cranbury, NJ (US)

(72) Inventors: Arbnor Ibraimi, Wanaque, NJ (US); Robert Clyde Finn, Westfield, NJ (US)

(73) Assignee: Innophos Inc., Cranbury, NJ (US)

(21) Appl. No.: 15/129,859

(22) PCT Filed: Mar. 30, 2015
(86) PCT No.: PCT/US2015/023409

§ 371 Date: Sep. 28, 2016

Related U.S. Application Data
(60) Provisional application No. 61/972,227, filed on Mar. 29, 2014.

(51) Int. Cl. A23K 20/22; A23K 20/26

(52) U.S. Cl. CPC A23K 20/22; A23K 20/26

(57) ABSTRACT

The present invention relates to compositions and methods for a pet food palatant composition including mixed alkali metal pyrophosphates.

### CROSS REFERENCE TO RELATED APPLICATION

This application is a national stage application under 35 U.S.C. 371 of International Application No. PCT/US2015/023409 filed Mar. 30, 2015, which claims priority under 35 U.S.C. 119(e) to U.S. Provisional Application No. 61/972,227 filed Mar. 29, 2014.

### BACKGROUND OF THE INVENTION

### Field of the Invention

The present invention relates to a pet food palatant composition of mixed alkali metal pyrophosphates.

Tetrasodium pyrophosphate (“TSPP”) and tetrapotassium pyrophosphate (“TKPP”) are widely used in phosphates blends for meat, seafood and poultry (“MSP”) applications to increase cooking yield and improve eating quality. Under the same usage level compared to sodium tripolyphosphate (“STPP”, which is the workhorse of the industry), TSPP and TKPP offer higher pH, higher ionic strength and more efficient specific protein solubility (in some cases, also referred to as a “pyro effect”). These are three fundamental working mechanisms for phosphates in meat applications (Xiong, Lou et al. 2000). With these benefits, TSPP and TKPP should work more efficiently than STPP and offer additional value to the MSP industry. However, in practical application their application is very limited because TSPP has very low solubility (5 g in 100 g water at 20° C.) and poor tolerance to brine solution and hard water. Although TKPP has much higher solubility, its use is also limited because of its high price and ultra-high hygroscopicity (Schrödter, Bettermann et al. 2000).

Desirable characteristics in pet food include high nutritional value, resistance to decomposition and bacterial contamination, low production costs, and a high degree of palatability. Pet food manufacturers strive to develop products that, on balance, optimize each of these characteristics. For certain products to be viable, a high degree of palatability must be maintained; otherwise the animal would not consume the food. This is due primarily to the selectivity that some animals demonstrate in their choice of food. Domestic cats, in particular, are highly sensitive to food's palatability.

Pet food can be classified as one of three types: canned or high moisture products (generally consisting of greater than 50% moisture); intermediate moisture products (consisting of about 15% to 50% moisture); and dry or low moisture products (consisting of less than 15% moisture). Canned products are typically made from all meat or meat by-products and, as a result, achieve particularly high palatably. While animals often prefer these products, they tend to be more costly to produce and package. Compared to canned products, intermediate moisture products can be formulated with a higher nutritional value and can be manufactured at a lower cost. However, like canned products, intermediate moisture products are susceptible to microbial contamination and decomposition and, therefore, must be stabilized by preservatives. In contrast to canned and intermediate moisture products, dry products do not require preservatives. Dry products can also be formulated to achieve an exceptionally high nutritional value and are relatively inexpensive to produce and package. The physical characteristics of dry food allows it to be conveniently stored and used, thus leading to a general preference for this type of food among both pet food manufacturers and pet owners. However, dry food is commonly less appealing to animals due to its relatively low palatability. As previously stated, low palatability is a particular problem in developing cat food because of cats' pronounced selectiveness in choosing food.

Dry pet food products are usually produced as pellets or kibbles of various shapes and sizes. The palatability of dry pet foods can be improved by coating the surface of the food pieces with a palatability enhancer. Traditional palatability enhancers consist of flavourings including amino acids, fat, brewer's yeast, dried whey, and dry or liquid meat digest made from beef, pork, poultry, fish, etc. Other known palatability enhancers include phosphoric acid; a combination of fat with hexamic, phosphoric, or citric acid; and a mixture of phosphoric acid and citric acid. These acids may be used by themselves or in conjunction with a traditional palatability enhancer to further improve the traditional enhancer's palatability. For example, U.S. Pat. No. 3,139,342 (Linskey) demonstrates a process for enhancing the taste and/or nutritional value of dry pet food pellets by coating them with fat or vitamins. In U.S. Pat. No. 3,615,847 (Kassens), the palatability of a porous, expanded pet food in the form of chunks is improved by the application of a coating of fat overlaid with a coating of dextrin. The use of both a traditional enhancer along with an acidic enhancer is typically accomplished by a two-step coating process wherein a flavorant is first topically applied as a coating and then this coating is overlaid with a spray of acidic enhancer. U.S. Pat. No. 3,679,429 (Mohrman) discloses a method of improving palatability of dry cat food by coating food pellets with fat and an additional acidic enhancer. U.S. Pat. No. 3,930,031 (Kealy) is directed to a cat food composition that is coated with a mixture of phosphoric and citric acids to enhance palatability. U.S. Pat. No. 5,188,964 (Gierhart et al.) discloses the use of phosphate, pyrophosphate and polyphosphate palatability enhancers, optionally combined with citric, tartaric, fumaric, lactic, acetic, formic or hexamic acids, and a flavorant.

As noted in U.S. Pat. No. 4,215,149 (Majlinger), acid palatability enhancers generally accelerate the oxidation of fat, thereby leading to the fat's degradation. For this reason, the use of an acid palatability enhancer in combination with a topically applied traditional fat-based enhancer is limited. The solution to this problem, as demonstrated by Majlinger, is to coat the food pellets with a salt of phosphoric acid, specifically monosodium phosphate or sodium acid phosphate (SAP), in the range of 0.25% to 2.0% by weigh.

Other improvements in palatability have been discussed in U.S. Pat. No. 8,254,920(Brunner) and U.S. Pat. No. 8,350,485 (Brunner). The Brunner patents disclose the use of 0.1% -99% by weight of tetrasodium pyrophosphate in palatability enhancer formulations.

Notwithstanding the known palatability enhancers, there remains a need for palatabliity enhancers that are more economic and convenient, yet maintain a high level of palatability.

### SUMMARY OF THE INVENTION

The present invention is directed to a mixed alkali metal pyrophosphate composition having multiple applications.

In a first embodiment, the invention is directed to a pet food palatant composition including a mixed alkali metal pyrophosphate compound having the formula: X₂Y₂P₂O₇ wherein X and Y are independently selected from the group consisting of Na, K, Li, and Cs. The mixed alkali pyrophosphate is prepared by spraying a mixed orthophosphate into a recycling bed of mixed alkali metal pyrophosphates at a kiln temperature of 350° C. to 550° C. This mixed alkali metal pyrophosphate is then blended with a pet food processing aid selected from the group consisting of amino acids, fats, brewer's yeast, dried whey, dry or liquid meat digest made from beef, pork, poultry, or fish, phosphoric acid: hexamic acid, citric acid, tartaric acid, fumaric acid, lactic acid, acetic acid, formic acid, phosphates, pyrophosphates, polyphosphates and mixtures thereof to form the palatant composition.

In another embodiment, the present invention is directed to a pet food palatant composition including 0.05 to 3% by weight of a mixed alkali metal pyrophosphate compound having the formula X₂Y₂P₂O₇ wherein X and Y are independently selected from the group consisting of Na, K, Li, and Cs. The mixed alkali metal pyrophosphate is prepared by spraying a mixed orthophosphate into a recycling bed of mixed alkali metal pyrophosphates at a kiln temperature of 350° C. to 550°C. This mixed alkali metal pyrophosphate is then blended with 1 to 99% by weight of a pet food processing aid selected from the group consisting of amino acids, fats, brewer's yeast, dried whey, dry or liquid meat digest made from beef, pork, poultry, or fish, phosphoric acid; hexamic acid, citric acid, tartaric acid, fumaric acid, lactic acid, acetic acid, formic acid, phosphates, pyrophosphates, polyphosphates and mixtures thereof to form the palatant composition.

In yet another embodiment, the present invention is directed to a pet food palatant composition including a mixed alkali metal pyrophosphate compound having the formula Na₄K₄(P₂O₇)₂ prepared by spraying water into a mixed bed of Na₄P₂O₇ and K₄P₂O₇. This mixed alkali metal pyrophosphate is then blended with a pet food processing aid selected from the group consisting of amino acids, fats, brewer's yeast, dried whey, dry or liquid meat digest made from beef, pork, poultry, or fish, phosphoric acid; hexamic acid, citric acid, tartaric acid, fumaric acid, lactic acid, acetic acid, formic acid, phosphates, pyrophosphates, polyphosphates and mixtures thereof to form the palatant composition.

### BRIEF DESCRIPTION OF THE DRAWINGS

FIG. 1 is a bar chart illustrating the % cook yield in a 50% extension meat loaf (first run) using various alkali metal pyrophosphates.

FIG. 2 is a bar chart illustrating the % cook yield in a 50% extension meat loaf (second run) using various alkali metal pyrophosphates.

FIG. 3 is a bar chart illustrating the % cook yield in a 15% extension tumbled chicken (first run) using various alkali metal pyrophosphates.

FIG. 4 is a bar chart illustrating the % cook yield in a 15% extension tumbled chicken (second run) using various alkali metal pyrophosphates.

FIG. 5 is a bar chart illustrating the % cook yield in a 50% extension meat loaf using various alkali metal pyrophosphates.

FIG. 6 is a process flow diagram for the manufacture of the mixed alkali pyrophosphate according to the present invention.

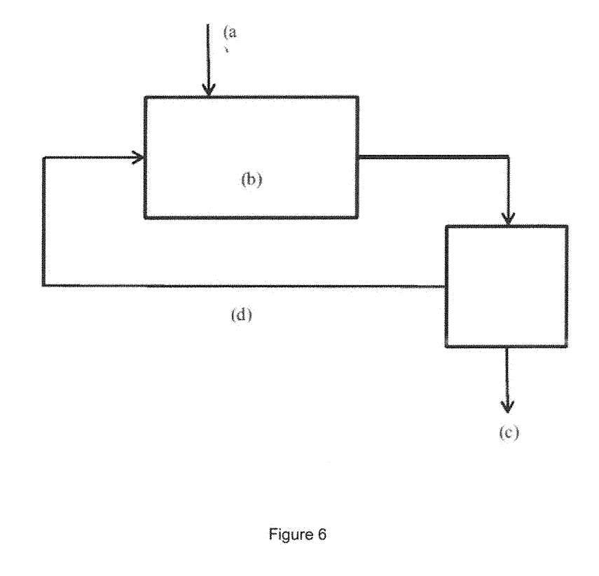

FIG. 7 is an X-ray diffraction pattern of the mixed alkali metal pyrophosphate of the present invention.

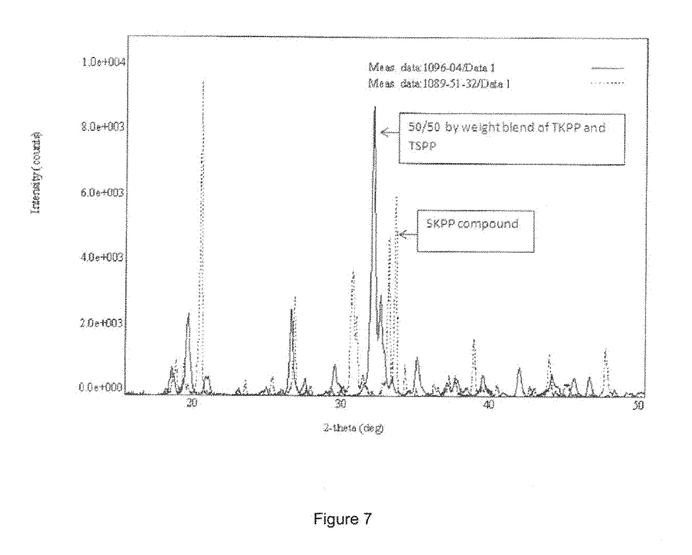

### DETAILED DESCRIPTION OF THE INVENTION

The present invention is directed to a mixed alkali metal pyrophosphate composition having multiple applications. More particularly, the present invention is directed to SKPP (sodium potassium pyrophosphate) as a chemical blend, not a physical blend of TSPP (tetra sodium pyrophosphate) and TKPP (tetra potassium pyrophosphate) with Na:K molar ratio of 1:1. Since it is hybrid compound of TSPP and TKPP, while matching the same benefits, such as high pH, high ionic strength and pyro effect, it overcomes certain deficiencies of TSPP and TKPP and offers a new solution for the MSP industry.

Table I provides a chemical/physical comparison of SKPP, TKPP, TSPP and blend T (45% TSPP+55% TKPP). The SKPP composition in Table I was prepared as provided in EXAMPLE 1. As illustrated, SKPP dissolves quickly in room temperature and cold water with clear appearance and offers higher ionic strength than STPP (˜5% solution, 28.2 ms Vs. 20.4 ms at RT). At 5% solution in RT and CW, SKPP maintained almost the same conductivity while STPP will drop from 20.1 ms to 18 ms, in cold water. SKPP dissolves better than STPP; however, SKPP also offers higher pH (1% solution, 10.3 vs. 9.8). Compared with blend T, which is the physical blend of TKPP and TSPP, SKPP and blend T are very similar with respect to pH, rate of solution (“ROS”) and solubility. However, SKPP is more tolerant to hard water and less hygroscopic. Compared with TSPP, SKPP improved solubility and ROS dramatically which was the bottle-neck of TSPP in MSP application. SKPP is ˜60 times less hygroscopic than TKPP and ˜10 times more than TSPP.

Based on the benefits illustrated in Table I, such as high pH, high solubility, excellent rate of dissolution, high ionic strength, low sodium, 100% pyro content, middle price between TSPP and TKPP, it is recognized that SKPP is a promising ingredient in the MSP commercial industry.

TABLE 1

| | | TSPP | TKPP | SKPP | Blend T | Comments |
|---|---|---|---|---|---|---|
| ROS at | Final | 23.7 | 31.8 | 28.2 | 28 | SKPP and blend T |
| room | conductivity | | | | | (physical blend of |
| temperature | (ms) | | | | | TSPP and TKPP) |
| (“RT”) | 30 | 91.14 | 97 | 94 | 93 | offer almost the same |
| | 240 | 100.00 | 100 | 100 | 100 | final ionic strength |
| | Observation | some | solution | Solution | solution clear | at RT. Much higher |
| | | particle on | clear | clear | | than TSPP |
| | | the bottom | | | | |
| ROS | Final | 18.86 | 31.3 | 27.5 | 27.3 | In cold water, |
| [[at]]in cold | conductivity | | | | | conductivity of SKPP |
| water | (ms) | | | | | does not change |
| (“CW”) | 30 | 77.25 | 95.8 | 97 | 95 | much [[,]] compared |
| | 240 | 99.83 | 99.0 | 99 | 100 | with [[in]] RT, while |
| | Observation | Solution | Solution | Solution | Solution clear | TSPP dropped |
| | | cloudy with | clear | clear | | significantly |
| | | lots [[m]]of | | | | [[. L]] argely due to its |
| | | particles | | | | solubility |
| 1% pH | | 10.4 | 10.3 | 10.27 | 10.29 | pH almost the same |
| Salt | (2.5% | 57 | 1.25 | 90.5 | 74.75 | almost the same ter |
| tolerance | phosphate, 5%, | | | | | chemical and physical |
| | salt) | | | | | blend |
| Water | 100 ppm | 95 | 1.4 | 1.8 | 10.2 | SKPP is much more |
| hardness | 50 ppm | 40.7 | N/A | N/A | 1.7 | tolerant to hard water |
| | | | | | | than TSPP and blend T |
| Hygro- | % increase | | | 12.40% | 27.20% | Blend T is more |
| scopicity | ambient | | | | | hygroscopic. Physical |
| | condition 20 hrs | | | | | blend cakes together |
| | % increase | 0.14 | 61.44 | 1.12 | 7.61 | |
| | (40° C., RH | | | | | |
| | 54%, 24 hr) | | | | | |
| Solubility | First Day in RT | 5% | 187% | 25%-30% | 25%-30% | |
| | Second day in | | | recrystallized | recrystallized | |
| | CW | | | | | |

As an illustration of the present invention, SKPP was evaluated in both ground meat (meat loaf) and whole muscle (chicken) application and compared against various phosphate blends and single compounds such as TSPP and TKPP.

### Materials and Methods:

### Part I. SKPP Application in Meat Loaves:

21 lb of ham was ground through a ½ inch plate and stored in a refrigerator for use on the second day. Five 1000 g solutions were made, each containing 4.5% salt and 1.5% of SKPP, STPP, Solo93 (potassium and sodium pyrophosphate blend, available from Innophos, Inc., Cranbury, N.J.). OptiBind (sodium polyphosphate, available from Innophos, Inc., Cranbury, N.J.), or Textur-Bind LS 1000 (60% STPP, 40% TKPP blend, available from Innophos, Inc. Cranbury, N.J.). For each treatment, 800 g of solution was added to 1600 g of ham and mixed for 3 minutes. Meat loaves having a weight of 300 g each were formed in aluminum pans from the mixtures. Half of them were cooked after 3 hours holding. The other half was cooked after 24 hours holding. The oven was preheated to 300° C. and the meat loaves were cooked at 0% humidity and 300° C. until their internal temperature reached 170° C. Yield, texture and sensory were evaluated aftenvards.

### Part II. SKPP Application in Tumbled Chicken Breast:

Five 1200 g of marinade was made, each containing 3.33% of salt and 3.33% of SKPP, STPP, Solo93, OptiBind, or Textur-Bind LS 1000 (60% STPP, 40% TKPP). Solution pH was checked and solution was chilled overnight. 20 boneless chicken breasts for each treatment were purchased. After trimming fat and loose pieces after maceration, they were all tagged and weighed. One treatment and 15% of the weight of that treatment as marinade was added to tumbler. Tumbler was vacuumed for 1 min, and tumbled at 12 RPM for 20 mins. After tumbling, surface pH and weight was recorded for both individual and whole set. The oven was preheated to 300° F. with 0% humidity and the chicken was cooked in two ovens with about the same weight in each oven (to accelerate cooking) until an internal temperature of 165° F. was achieved. Yield, texture and sensory were evaluated afterwards.

Part III. SKPP Application in Meat Loaf, Compared with TSPP, TSPP and Physical Blend of TSPP and TKPP; Procedure is Similar to Part I.

### Results and Discussion:

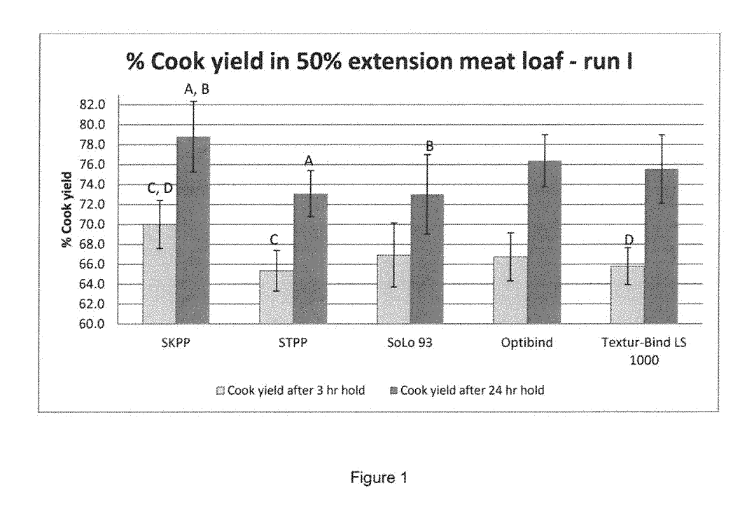

Reference is made to FIG. 1, The same tetter (A, B, C or D) in different treatments indicated significant difference (P<0.05) based on analysis of variance (“ANOVA”) by F-test (“Fisher's, test”) (e.g., for A, SKPP is significantly different from STPP after 24 hour hold). No significant difference was found by Tukey's test.

The two meat loaf runs (run I and run II) indicated that SKPP offer higher cooking yield, normally 2-5% more than STPP and the other meat blends. The difference was significant by Fisher's test in certain cases (see letters in FIGS.) while no significant difference was found by Tukey's test. The SKPP-treated sample was found to be moister with no aftertaste or bitter taste noticed.

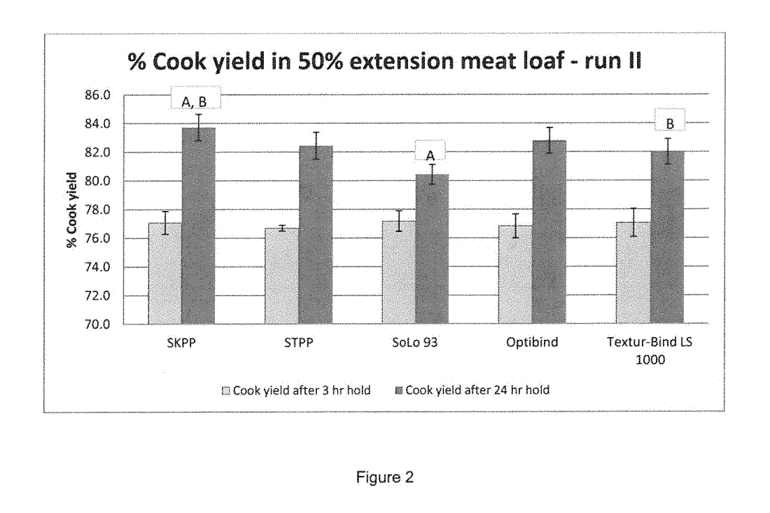

Reference is made to FIG. 2, The same letter in different treatments indicated significant difference (P<0.05) based on analysis of variance (“ANOVA”) by F-test (“Fisher's test”). No significant difference was found by Tukey's test.

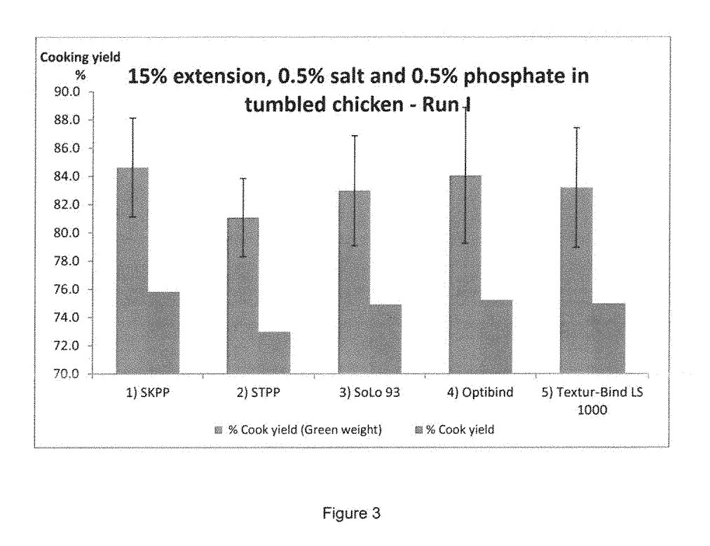

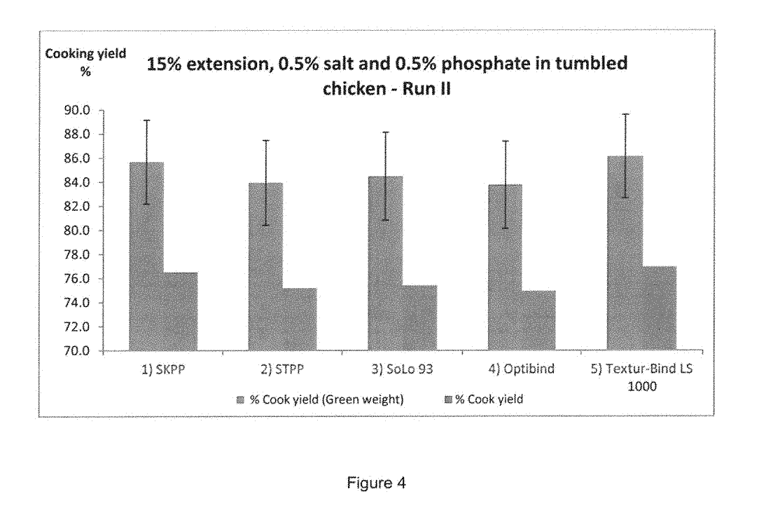

Reference is made to FIGS. 3 and 4. In the tumbled chicken application, the cooking yield advantage of SKPP-treated chicken was not as obvious as the SKPP-treated meat loaf. In most cases, the average is a little bit higher, but there was no significant difference compared with the other phosphate-treated ones. Regarding flavor, it was similar to the others and there was no aftertaste or bitterness sensed.

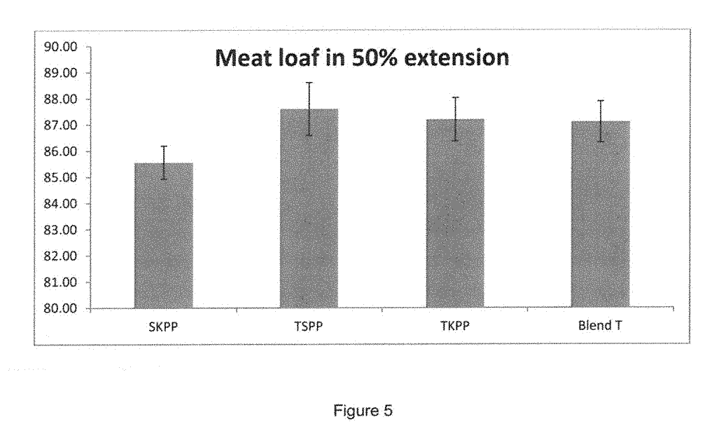

Reference is made to FIG. 5. Compared to TSPP, TKPP and the physical blend of TSPP and TKPP (Blend T), SKPP had slightly lower cooking yield and it was statistically significant (P<0.05). Taste and texture were very similar.

In another embodiment, the invention is directed towards a pet food palatant composition including a mixed alkali metal pyrophosphate compound having the formula:

X₂Y₂P₂O₇

wherein X and Y are independently selected from the group consisting of Na, K, Li, and Cs. The mixed alkali metal pyrophosphate is prepared by spraying a mixed orthophosphate into a recycling bed of mixed alkali metal pyrophosphates at a kiln temperature of 350° C. to 550° C. This mixed alkali metal pyrophosphate is then blended with a pet food processing aid selected from the group consisting of amino acids, fats, brewer's yeast, dried whey, dry or liquid meat digest made from beef, pork, poultry, or fish, phosphoric acid; hexamic acid, citric acid, tartaric acid, fumaric acid, lactic acid, acetic acid, formic acid, phosphates, pyrophosphates, polyphosphates or mixtures thereof.

In another embodiment, the present invention is directed to a pet food palatant composition including 0.05 to 3% by weight of a mixed alkali metal pyrophosphate compound having the formula X₂Y₂P₂O₇ wherein X and Y are independently selected from the group consisting of Na, K, Li, and Cs prepared by spraying a mixed orthophosphate into a recycling bed of mixed alkali metal pyrophosphates at a kiln temperature of 350° C. to 550° C., and 1 to 99% by weight of a pet food processing aid selected from the group consisting of amino acids, fate, brewer's yeast, dried whey, dry or liquid meat digest made from beef, pork, poultry, or fish, phosphoric acid; hexamic acid, citric acid, tartaric acid, fumaric acid, lactic acid, acetic acid, formic acid, phosphates, pyrophosphates, polyphosphates and mixtures thereof

In yet another embodiment, the present invention is directed to a pet food palatant composition including a mixed alkali metal pyrophosphate compound having the formula Na₄K₄(P₂O₇)₂, prepared by spraying water into a mixed bed of Na₄P₂O₇ and K₄P₂O₇, and a pet food processing aid selected from the group consisting of amino acids, fats, brewer's yeast dried whey, dry or liquid meat digest made from beef, pork, poultry, or fish, phosphoric acid; hexamic acid, citric acid, tartaric acid, fumaric acid, lactic acid, acetic acid, formic acid, phosphates, pyrophosphates, polyphosphates and mixtures thereof.

### Definitions and Usages of Terms

“Pet food processing aid” as used herein means any additive used in the manufacture of pet food to enhance palatabliity, ease of processing, shelf life and nutritional value. Pet food processing aids known to those skilled in the art include, but are not limited to, traditional palatability enhancers such as amino acids, fat, brewer's yeast, dried whey, and dry or liquid meat digest made from beef, pork, poultry, fish, etc. Other known palatability enhancers include phosphoric acid; hexamic acid, citric acid, tartaric acid, fumaric acid , lactic acid, acetic acid and formic acid. Phosphates, pyrophosphates and polyphosphates are also known to those skilled in the art of pet food processing,

“Recycling Bed”—The process of the present invention is carried out in a kiln. Specifically, in the external recycle portion of the kiln, a portion of the mixed salt product is sent forward as a finished mixed salt product and the remainder is re circulated back to the feed end to form the “recycling bed”. One skilled in the art would recognize, in an embodiment of the invention, the aforementioned recycling step is eliminated.

“Mixed orthophosphates” as used herein include, but are not limited to, mixtures of monobasic (MH₂PO₄ ) and dibasic orthophosphates (M₂HPO₄ ) as well as mixtures where two metals are present (M₁H₂PO₄/M₂H₂PO₄ where both M₁ and M₂ are different metals from a list including Li, Na, K, Rb and Cs). Combinations therein are included as well.

### EXAMPLES

The following non-limiting examples illustrate the practice of the present invention. Examples 1-6 relate to the preparation of the mixed alkali metal pyrophosphate.

### Example 1

Referring to FIG. 1, a mixed orthophosphate is sprayed into a recycling bed (a) of a kiln (b) at a temperature of 350° C. to 550° C. A portion of the product (c) is screened and packed at point (d). The remaining product is recycled back into the kiln (b). In another embodiment of the invention, the recycling back into the kiln step is eliminated. FIG. 2 illustrates the product—a 50/50 blend of TSPP and TKPP—formed by the process of the present invention.

### Example 2

A physical mixture of TKPP (tetrapotassium pyrophosphate) and TSPP (tetrasodium pyrophosphate) at molar ratio of 1:1 was hydrated with 15% water. The hydrated mixture was dried in a rotary dryer (kiln) at 200° C., yielding 93.8% sodium-potassium pyrophosphate and 6.2% mixed sodium and potassium orthophosphate with pH value of 10.25. This unique “ion-exchange” method of production occurs without the use of an acid/base driving force/catalyst.

### Example 3

The hydrated blend of TSPP and TKPP from Example 1 was dried at product temperatures of 345° C. to 400° C., yielding 98.55% sodium-potassium pyrophosphate with a pH of 10.25.

### Example 4

Sodium potassium pyrophosphate was prepared by condensing (calcining) sodium potassium orthophosphate mixture directly from solution. Solution of mixed orthophosphate was prepared dissolving NaH₂PO₄ and adding KOH to the molar ratio of (Na+K)/P of about 2. The solution of sodium potassium orthophosphate was dosed (sprayed) into the hot recycled bed of sodium potassium: pyrophosphate from Example 2 and calcined at a temperature range from 350° C. to 430° C. The prepared mixed pyrophosphate had an assay of 97% to 98.97% sodium potassium pyrophosphate.

### Example 5

A solution of TSPP and TKPP was prepared by reacting STPP with NaOH to form TSPP. TKPP was charged into this prepared solution to make a 48.6% solution of sodium potassium pyrophosphate. The solution of sodium potassium pyrophosphate was calcined directly in the rotary dryer (kiln) by dosing into the hot recycled bed of Example 2 at temperature ranges from 340° C. to 390° C.

### Example 6

A starting recirculation bed was prepared by combining TKPP solution and re-cycled bed of TSPP directly in the kiln. Solution containing 40% to 47% TKPP was sprayed into hot bed of TSPP at product temperatures from 270° C. to 430° C. After reaching a mixture of TKPP and TSPP at molar ratio of 1:1, sodium potassium pyrophosphate was formed. The reaction of formation of the true mixed sodium potassium pyrophosphate occurred at temperatures from 270° C. to 340° C. (below 355° C.) with partial hydrolysis to sodium potassium orthophosphate (below 300° C.). The prepared sodium pyrophosphate would have 95.45% total assay as pyrophosphate, containing only 0.74% as TSPP.

The mixed alkali metal pyrophosphates prepared in EXAMPLES 1-6 can be blended with pet food processing aids to produce the palatant composition of the present invention. Pet food processing aids known to those skilled in the art include, but are not limited to, traditional palatability enhancers such as amino acids, fat, brewer's yeast, dried whey, and dry or liquid meat digest made from beef, pork, poultry, fish, etc. Other known paiatabiiity enhancers include phosphoric acid; hexamic acid, citric acid, tartaric acid, fumaric acid, lactic acid, acetic acid and formic acid. Phosphates, pyrophosphates and polyphosphates are also known to those skilled in the art of pet food processing.

Additional examples relate to the preparation of the palatant compositions comprising the mixed alkali metal pyrophosphates made according to the present process. Expected uses for SKPP are based on ‘read across’ data from TKPP, TSPP and basic polyphosphates.

Dairy applications—pyrophosphates are known to be used in dairy applications as emulsifying salt for both texture and melt properties. TSPP is also known a dispersant in buttermilk, pudding and chocolate milk. In puddings the pyrophosphate can act as a cross linker to modify the viscosity and texture.

Detergents, dispersants and chelants—sodium phosphates are commonly used in these markets as well.

It will be appreciated by those skilled in the art that SKPP advantages over TSPP include better solubility and advantages over TKPP include that SKPP is less prone to water absorption through the air (is less hygroscopic); these will provide a commercial advantage in any use which includes the SKPP of the present invention.

1. A mixed alkali metal pyrophosphate composition comprising a chemical blend of TSPP (tetra sodium pyrophosphate) and TKPP (tetra potassium pyrophosphate) with Na:K molar ratio of 1:1.

2. The composition of claim 1, wherein the composition is SKPP (sodium potassium pyrophosphate).

3. A pet food palatant composition comprising:
a. a mixed alkali metal pyrophosphate compound having the formula:
X₂ Y₂P₂O₇
wherein X and Y are independently selected from the group consisting of Na, K, Li, and Cs, prepared by spraying a mixed orthophosphate into a recycling bed of mixed alkali metal pyrophosphates at a kiln temperature of 350° C. to 550° C.; and
b. a pet food processing aid selected from the group consisting of amino acids, fats, brewer's yeast, dried whey, dry or liquid meat digest made from beef, pork, poultry, or fish, phosphoric acid; hexamic acid, citric acid, tartaric acid, fumaric acid, lactic acid, acetic acid, formic acid, phosphates, pyrophosphates, polyphosphates and mixtures thereof.

4. The pet food palatant composition according to claim 3, wherein the mixed alkali metal pyrophosphate compound is present in an amount of 0.5 to 3.0% by weight of the composition, and the pet food processing aid is present in an amount of 1.0 to 99.0% by weight of the composition.

5. A method of preparing a mixed alkali metal pyrophosphate consisting of the steps of:
i. preparing a physical mixture of TSPP (tetra sodium pyrophosphate) and TKPP (tetra potassium pyrophosphate) having a Na:K molar ratio of 1;
ii. hydrating the physical mixture with 15% water; and
iii. drying the physical mixture in a rotary dryer at 200° C.

6. The mixed alkali metal pyrophosphate made by the method of claim 5, wherein the mixed alkali metal pyrophosphate is 93.8% SKPP (sodium potassium pyrophosphate) and 6.2% sodium and potassium orthophosphate with a pH value of 10.25.
